(19) United States
(12) Patent Application Publication
(10) Pub. No.: US 2026/0017220 A1
(43) Pub. Date: Jan. 15, 2026

(54) SYSTEM AND METHOD FOR EFFICIENT DATA STREAMING AND BUFFERING IN AN FPGA-BASED SPI DEVICE INTERFACE WITH A HOST COMPUTER

(71) Applicant: EigenQ, Inc., Columbia, MD (US)

(72) Inventors: Raul I. Zuleta Ticchione, Columbia, MD (US); Jose R. Rosas-Bustos, Columbia, MD (US); Jesse Van Griensven Thé, Columbia, MD (US); Mark Pecen, Columbia, MD (US)

(21) Appl. No.: 19/267,995

(22) Filed: Jul. 14, 2025

Related U.S. Application Data
(60) Provisional application No. 63/671,442, filed on Jul. 15, 2024.

(51) Int. Cl. G06F 13/40; G06F 13/42

(52) U.S. Cl. CPC G06F 13/4059; G06F 13/4282

(57) ABSTRACT

The present disclosure relates to a serial peripheral interface (SPI) device interface system and method that leverages the capabilities of a Field Programmable Gate Array (FPGA) to enable high-speed, flexible, and reliable communication between a host computer and one or more SPI devices. The system comprises a host computer, an FPGA bridge, and at least one SPI device connected to the FPGA bridge. The FPGA bridge includes a Host to Device Controller module for managing communication with the host computer, a Data Streaming Controller module for handling data transfer between the host computer and the SPI devices, and an SPI Master Controller module for controlling the SPI communication with the SPI devices.

### CROSS-REFERENCE TO RELATED APPLICATIONS

This application claims priority to and the benefit of U.S. provisional application No. 63/671,442, filed on Jul. 15, 2024, which is expressly incorporated by reference herein in its entirety.

### BACKGROUND

Traditionally, host computers communicate with peripheral devices using various interface standards, such as Universal Serial Bus (USB), Universal Asynchronous Receiver/Transmitter (UART), Inter-Integrated Circuit (I2C), and Serial Peripheral Interface (SPI). Among these, SPI has gained popularity due to its simplicity, full-duplex operation, and high-speed data transfer capabilities. However, interfacing a host computer directly with SPI devices can be challenging, especially when dealing with multiple devices, different clock speeds, and diverse communication protocols.

To address these challenges, Field Programmable Gate Arrays (FPGAs) have been employed as intermediary devices between the host computer and SPI peripherals. FPGAs offer flexibility, parallelism, and high-speed processing capabilities, making them suitable for handling complex communication tasks and protocol conversions. Prior art solutions have explored various architectures and techniques for FPGA-based SPI device interfaces.

For example, U.S. Pat. No. 9,778,981 discloses a system and method for interfacing a host computer with an SPI device using an FPGA. The FPGA acts as a bridge, receiving commands from the host computer and translating them into SPI transactions. However, the disclosure does not address efficient data streaming and buffering techniques or advanced communication protocols.

U.S. Patent Application Publication No. 2018/0004283 describes an FPGA-based SPI master controller that supports multiple SPI slave devices. The controller includes a command decoder, a finite state machine, and a shift register for handling SPI transactions. While this application provides a foundation for multi-device SPI communication, it lacks optimized data streaming and buffering mechanisms.

Other related art, such as U.S. Pat. No. 8,909,851 and U.S. Patent Application Publication No. 2015/0220473, discuss FPGA-based SPI controllers and techniques for improving SPI communication performance. However, these systems do not comprehensively address the challenges of efficient data streaming, buffering, and advanced communication protocols in a host-FPGA-SPI system.

Consequently, there remains a need for an improved system and method that combines an FPGA-based SPI device interface with efficient data streaming and buffering techniques, along with optimized communication workflow and protocols. The present system addresses these limitations and provides a holistic solution for high-performance, reliable, and scalable communication between a host computer and SPI devices through an FPGA bridge.

### SUMMARY

One aspect of the present disclosure provides a system and method for efficient data streaming and buffering in an FPGA-based SPI device interface with a host computer. The system addresses the limitations of existing solutions by offering a comprehensive approach that combines an optimized FPGA-based SPI device interface, advanced data streaming and buffering techniques, and a streamlined communication workflow and protocol.

In one implementation, the system comprises a host computer, an FPGA bridge, and one or more SPI devices. The FPGA bridge acts as an intermediary between the host computer and the SPI devices, facilitating high-speed, low-latency communication. The FPGA includes a Host to Device Controller module, which receives commands and data from the host computer and manages the overall communication process.

The system and method of the disclosure incorporates data streaming and buffering techniques, including the use of FIFO and Block RAM (BRAM) buffers within the FPGA. This enables seamless and efficient data management between the host computer and the SPI devices, particularly facilitating the handling of high-speed data streams and minimizing latency. These techniques include the use of dedicated data buffers, such as FIFOs and Block RAMs, to temporarily store and manage data. The FPGA may also incorporate a Data Streaming Controller, which optimizes data flow and ensures reliable transmission between the host computer, the FPGA, and the SPI devices.

Furthermore, the system and method of the disclosure defines an optimized communication workflow and protocol stack that streamlines the interaction between the host computer, the FPGA, and the SPI devices. This includes a set of well-defined commands, data formats, and handshaking mechanisms that ensure efficient and error-free communication.

One aspect of the optimization is achieved through the use of differential clocks and precise timing for the output and buffering of each SPI source. This optimized precision timing ensures that data from multiple SPI sources are synchronized and serialized at high speed, forming the final output of the system. By employing differential clocks, signal degradation may be reduced and the integrity of high-speed data transmission enhanced, further improving overall performance.

The disclosure supports multiple SPI devices with different clock speeds and communication protocols, providing flexibility and scalability. In one implementation, the FPGA bridge can be configured to handle various SPI modes, clock polarity, and phase settings, enabling compatibility with a wide range of SPI devices.

By implementing the proposed system and method, superior data transfer performance, reliability, and scalability is achieved compared to prior art solutions. The optimized data streaming and buffering techniques minimize latency and maximize throughput, while the streamlined communication workflow and protocol ensure efficient and error-free data exchange between the host computer and the SPI devices

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a block diagram illustrating an overview of the system architecture, depicting a host computer, an FPGA bridge, and SPI devices, in accordance with an embodiment of the present system.

FIG. 2 illustrates a detailed block diagram of the FPGA bridge, showing the internal components and modules, including a Host to Device Controller, a Data Streaming Controller, and an SPI Master Controller, in accordance with an embodiment of the present system.

FIG. 3 illustrates is a block diagram representing an exemplary embodiment of the system, wherein the FPGA-based SPI device interface is utilized in a high-speed data acquisition system, in accordance with an embodiment of the present system.

FIG. 4 illustrates a block diagram representing an exemplary embodiment of the system, wherein the FPGA-based SPI device interface is utilized in a quantum random number generator system, in accordance with an embodiment of the present system.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

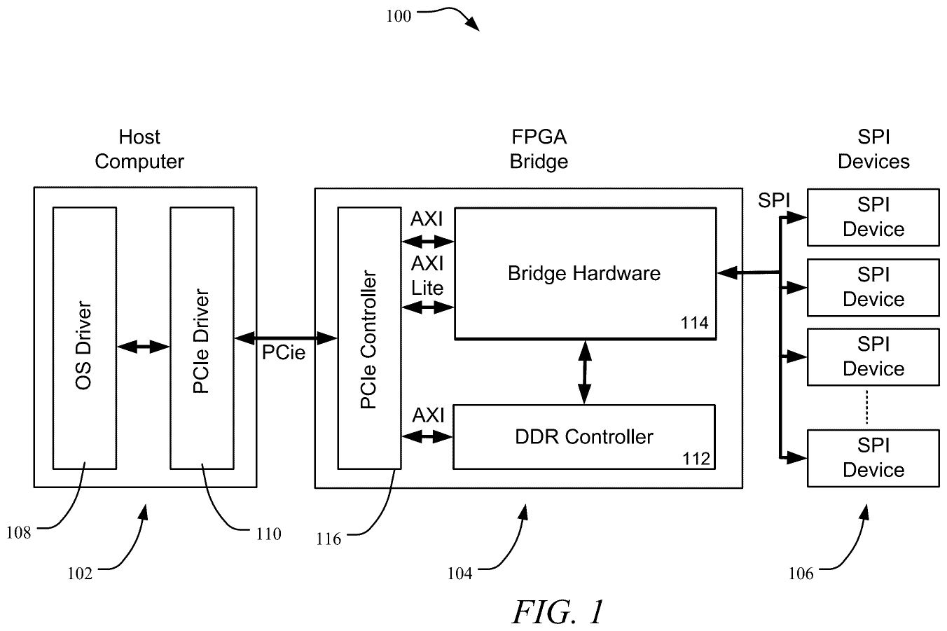

Provided herein is a system and method for efficient data streaming and buffering in an Field Programmable Gate Array (FPGA)-based Serial Peripheral Interface (SPI) device interface with a host computer, such as shown in FIG. 1. In general, the system 100 illustrated in FIG. 1 may comprise three main components: a host computer 102, an FPGA bridge 104, and one or more SPI devices 106. The host computer is generally responsible for issuing commands and transferring data to the SPI devices 106 through the FPGA bridge 104. The host computer 102 may communicate with the FPGA bridge 104 using a high-speed interface, such as Peripheral Component Interconnect Express (PCIe), Universal Serial Bus (USB), Ethernet, or the like. The host computer 100 may also run software applications that generate data for or acquire data from the SPI devices 106, actively managing the system's overall operation. The primary communication interface for these data transactions is specified as PCIe, although alternatives such as USB or Ethernet may also be utilized depending on system requirements.

The FPGA bridge 104 generally acts as an intermediary between the host computer 102 and the SPI devices 106 by receiving commands and data from the host computer, processing the commands and data, and communicating with the SPI devices accordingly. In some instances, the FPGA bridge 104 may be a reconfigurable hardware device that can be programmed to implement various communication protocols, data processing algorithms, and custom logic functions. The FPGA bridge 104 includes several internal components and modules, such as a Host to Device Controller, a Data Streaming Controller, and a SPI Master Controller, which are described in greater detail below.

The SPI devices 106 are generally peripheral components that communicate with the FPGA bridge 104 using a Serial Peripheral Interface (SPI) protocol. In general, SPI is a full-duplex, synchronous, serial communication protocol used in embedded systems, sensors, and other peripheral devices. SPI devices 106 can be sensors, actuators, memory devices, or any other components that support the SPI protocol. The system 100 may support multiple SPI devices 106, in some instances with different clock speeds and communication protocols, allowing for flexibility and scalability.

Communication between the host computer 102, the FPGA bridge 104, and the SPI devices 106 may follow a well-defined workflow and protocol stack. In general, the host computer 102 may transmit commands and data to the FPGA bridge 104 (such as through the PCIe connection), which then processes and forwards them to the appropriate SPI devices 106. In one implementation, the host computer 102 may include an operating system driver 108 to generate the one or more communications to the FPGA bridge 104 and transmit said communications to a PCie Driver 110 for conversion into one or more PCIe packets. The converted PCIe packets may then be transmitted to the FPGA bridge 104.

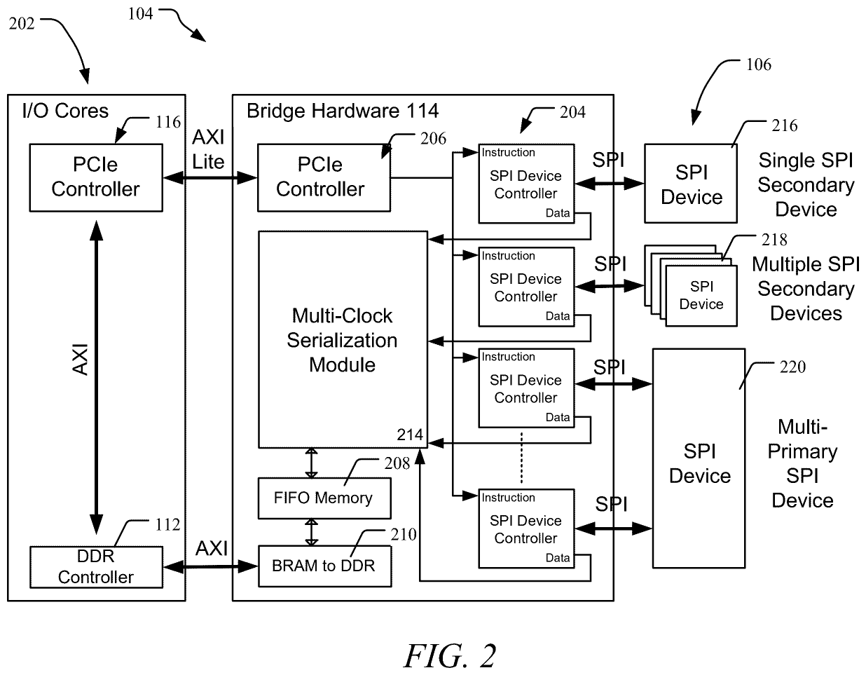

In some implementations, the FPGA bridge 104 employs efficient data streaming and buffering techniques to ensure high-speed, low-latency data transfer between the host computer 102 and the SPI devices 106. The communication protocol may include mechanisms for error detection, flow control, and synchronization, ensuring reliable and efficient data exchange. Such mechanisms are described in greater detail below. The architecture of the disclosed system is designed to be modular and scalable, allowing for easy integration of additional SPI devices or modification of existing components. For example, the FPGA bridge 104 can be configured to support different communication interfaces, data processing algorithms, and custom logic functions, depending on the specific requirements of the application. The operations and components of the FPGA bridge 104 is discussed in more detail with reference to FIGS. 2-5 below.

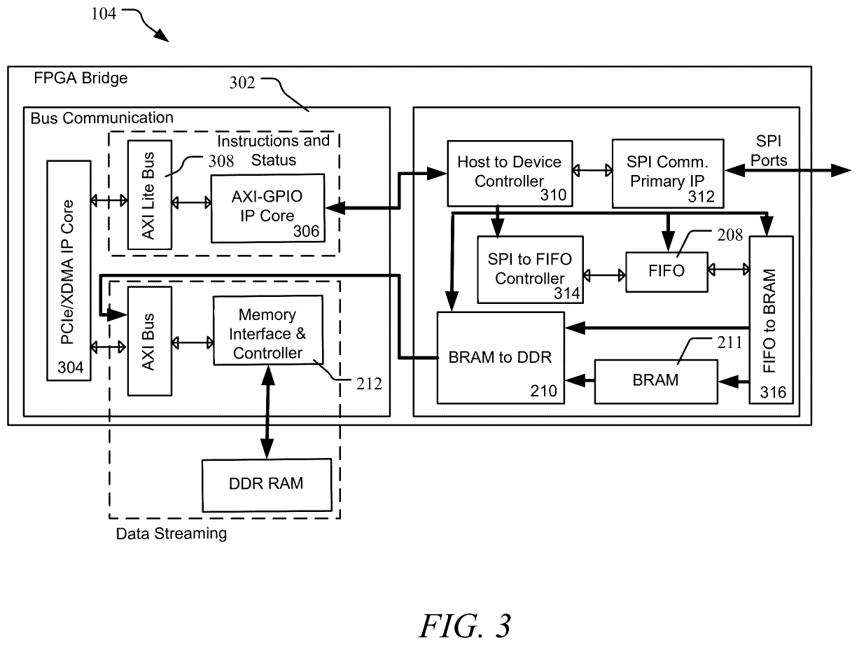

Embodiments of the FPGA Bridge 104 according to the Present Disclosure are illustrated in FIGS. 2 and 3 and discussed below. In particular, FIG. 2 illustrates a detailed block diagram of the FPGA bridge, showing the internal components and modules and FIG. 3 illustrates is a block diagram representing an exemplary embodiment of the system, including a Host to Device Controller, a Data Streaming Controller, and an SPI Primary Controller, and the like in accordance with an embodiment of the present system. The features, operations, and interconnects of the components of the FPGA Bridge 104 discussed in greater detail below.

As shown in FIG. 2, the FPGA Bridge 104 may include one or more I/O cores 202 to receive instructions and messages from a host computer 102. In some instances, the I/O cores 202 may include a PCIe controller 116 in communication with a corresponding PCIe controller 206 of the custom hardware 114 for exchanging messages between the I/O cores 202 and the rest of the FPGA Bridge 104. In one implementation, the messages may be transmitted in an Advanced Extensible Interface (AXI) or AXI Lite message format, although other message formats are contemplated. As more clearly shown in FIG. 3, the FPGA Bridge 104 may include a bus communication portion 302 for receiving the messages from the I/O cores 202 and providing the received communications to other components of the bridge. As should be appreciated, the components and configuration of components of the FPGA Bridge 104 in FIGS. 2 and 3 are but one example of a bridge according to concepts described herein.

In one implementation, the bus communication portion 302 of the FPGA Bridge 104 may include a PCIe core 304 in communication with an AXI-GPIO core 306 via an AXI LiteBus 308. The PCIe core 304 may utilize the AXI-GPIO core 306 to provide instructions and/or status messages to a Host to Device Controller 310 of the FPGA Bridge 104. The bus communication portion 302 may also include data streaming 312, described in more detail below. Through the AXI pipeline, the I/O Cores 202 of the FPGA Bridge 104 may provide instructions and/or status messages to other components of the Bridge in response to instructions and status messages received from the host computer 102 for communication with the one or more SPI devices 106.

The Host to Device Controller 310 of the FPGA bridge 104 manages the communication between the host computer 102 and the FPGA bridge and serves as the primary interface for receiving commands and data from the host computer and orchestrating the overall data transfer process. As such, the Host to Device Controller 310 may be designed to support various communication interfaces, such as PCIe, USB, or Ethernet, depending on the specific requirements of the system. The controller 310 includes the necessary logic and buffers to handle the protocol-specific communication with the host computer 102, ensuring efficient and reliable data transfer. The main functionalities of the Host to Device Controller 310 are as follows:
Command Interpretation: The Host to Device Controller 310 receives commands from the host computer 102, via the instructions and status communication pipeline discussed above, and interprets the commands to determine the desired action. This determination may include decoding the commands and extracting relevant information, such as the target SPI device 106, the operation type (read/write), and/or the data size.
Data Buffering: The Host to Device Controller 310 may further utilize dedicated buffers, such as FIFOs (First-In-First-Out) 208 or Block RAMs 211, to temporarily store the data received from the host computer 102. The Host to Device Controller 310 may, in some instances, utilize a SPI to FIFO Controller 314 to provide data to a FIFO 208 memory device. The FPGA Bridge 104 may also include a FIFO to BRAM device 316 for transferring data from the FIFO 208 to the BRAM memory 211. These buffers act as a bridge between the host interface and the internal data processing logic described in more detail below, allowing for smooth and efficient data flow.
Flow Control: The Host to Device Controller 310 implements flow control to ensure that the data transfer between the host computer 102 and the FPGA 104 is synchronized and regulated. It monitors the status of the internal buffers and provides feedback to the host computer 102 to prevent overflow or underflow conditions.
Error Handling: The Host to Device Controller 310 incorporates error detection and handling mechanisms to ensure the integrity of the received data. It checks for communication errors, such as packet loss or corruption, and takes appropriate actions, such as requesting retransmission or notifying the host computer of the error condition.
Command Dispatch: Once the received commands are interpreted and the data is buffered, the Host to Device Controller 310 dispatches the commands and data to the appropriate internal modules within the FPGA bridge. The Host to Device Controller 310 routes the commands and data to the Data Streaming Controller 212 (also referred to as the Memory Interface & Controller in FIG. 3) or the SPI Primary Controller 312 (labeled as SPI Comm. Primary IP in FIG. 3), depending on the specific operation requested by the host computer 102.
Serialization: The Host to Device Controller 310 also implements a serialization process of the SPI device data. In one example, a multi-clock serialization module 214 runs at a fast clock frequency collecting data from the slow clock frequency SPI devices 106 in a non-blocking fashion. This allows the incorporation of extra SPI devices 106 with no changes in the core design. In addition, the multi-clock serialization module 214 allows for the FGPA Bridge 104 to communication with many types of SPI device 106, including but not limited to, single SPI secondary devices 216, multiple SPI secondary devices 218, and/or multi-primary SPI devices 220.

The Host to Device Controller 310 is, in one example, implemented using hardware description languages (HDLs) such as VHDL or Verilog, although other languages may also be used. In some examples, the Controller 310 is synthesized and configured onto a FPGA fabric, taking advantage of the FPGA's parallel processing capabilities and reconfigurability. In summary, the Host to Device Controller 310 handles command interpretation, data buffering, flow control, error handling, and command dispatch, ensuring efficient and reliable data transfer between the host computer and the internal modules of the FPGA bridge.

The present system employs advanced data streaming and buffering techniques to ensure seamless data transfer between the host computer 102, the FPGA bridge 104, and the SPI devices 106. In one implementation, the data streaming and buffering techniques are implemented within a Data Streaming Controller 112 of the FPGA bridge 104. This Controller 112 is responsible for managing the flow of data between the Host Computer 102 to the Host to Device Controller 310, the internal buffers, and the SPI Primary Controller 214. The key components and techniques employed in the Data Streaming Controller 112 are as follows:
Circular Buffers: In addition to FIFO buffers 208, the Data Streaming Controller 112 implements circular buffers using Block RAMs (BRAMs) 211 available on the FPGA. Circular buffers provide an efficient way to store and access data in a continuous, wraparound manner. They are particularly useful for buffering large amounts of data and supporting burst transfers.
Data Packing and Unpacking: The Data Streaming Controller 112 includes logic for data packing and unpacking to optimize the data transfer efficiency. It can pack multiple smaller data elements into larger data words, reducing the number of transfers required and improving the overall throughput. Similarly, it can unpack larger data words into smaller elements for compatibility with the SPI device interface 204.
Burst Transfer Support: The Data Streaming Controller 112 supports burst transfers, which allow for the transmission of multiple data elements in a single transaction. Burst transfers significantly reduce the overhead associated with individual transactions and improve the data transfer efficiency. The Data Streaming Controller 112 manages the buffering and flow control mechanisms to enable seamless burst transfers between the host computer 102, the FPGA 104, and the SPI devices 106.
Adaptive Buffer Management: The Data Streaming Controller 112 incorporates adaptive buffer management techniques to optimize the utilization of the available buffer space. It dynamically adjusts the buffer thresholds and allocation based on the real-time data transfer requirements, ensuring optimal performance, and minimizing the risk of buffer overflow or underflow.
Flow Control and Synchronization: The Data Streaming Controller 112 implements advanced flow control and synchronization to ensure reliable data transfer between the different components of the system. It uses handshaking signals, such as ready/valid signals, to coordinate the data transfer between the Host to Device Controller 310, the internal buffers, and the SPI Primary Controller 214. This ensures that data is transferred only when both the source and destination are ready, preventing data loss or corruption.
Error Detection and Recovery: The Data Streaming Controller 112 incorporates error detection and recovery mechanisms to maintain data integrity during the streaming process. It can detect and handle various error conditions, such as buffer overflow, underflow, or data corruption. In case of errors, it can initiate appropriate recovery actions, such as retransmission or error notification, to ensure the reliability of the data transfer.

By employing these advanced data streaming and buffering techniques, the FPGA Bridge 104 achieves high-speed, low-latency, and reliable data transfer between the host computer 102 and the SPI devices 106. The efficient utilization of FIFO buffers, circular buffers, data packing/unpacking, burst transfers, adaptive buffer management, flow control, and error handling mechanisms ensures optimal system performance and data integrity.

The FPGA Bridge 104 communication workflow and protocols define the sequence of steps and the rules governing the interaction between the host computer 102, the FPGA bridge 104, and the SPI devices 106. The present system establishes a well-defined communication workflow and a set of protocols to ensure efficient, reliable, and synchronized data transfer among the system components.

In general, the communication workflow can be divided into three main phases: initialization, data transfer, and termination. The initialization phase may include several operations. For example, the host computer 102 initializes the FPGA bridge 104 by sending configuration commands to set up the communication parameters, such as the SPI timing parameters, mode, and device selection. The FPGA bridge 104 acknowledges the configuration commands and configures its internal modules, including the Host to Device Controller 310, the Data Streaming Controller 112, and the SPI Primary Controller 114, accordingly. The host computer 102 sends a device discovery command to identify the connected SPI devices 106 and their capabilities. Finally, the FPGA bridge 104 probes the SPI bus, detects the connected devices, and reports their information back to the host computer 102.

In the data transfer phase, the host computer 102 sends data transfer commands to the FPGA bridge 104, specifying the target SPI device 106, the operation type (read/write), and the data size. The Host to Device Controller 310 receives the commands and data from the host computer 102 and forwards them to the Data Streaming Controller 112. The Data Streaming Controller 112 buffers the received data using its internal FIFO buffers 208 and circular buffers, applying data packing/unpacking and burst transfer techniques as needed. The Data Streaming Controller 112 initiates the data transfer to the SPI Primary Controller 214, which handles the low-level SPI communication with the target SPI device 106. The SPI Primary Controller 214 generates the necessary SPI control signals (e.g., chip select, clock, MOSI) and transfers the data to/from the SPI device 106 according to the specified operation type. The SPI device 106 responds to the SPI commands and data, and the SPI Primary Controller 214 receives the response data. The received data is then passed back through the Data Streaming Controller 112, where it is buffered and processed as needed. The Data Streaming Controller 112 then forwards the processed data to the Host to Device Controller 310, which sends it back to the host computer 102.

In the termination phase and once the data transfer is complete, the host computer 102 sends a termination command to the FPGA bridge 104. The FPGA bridge 104 acknowledges the termination command and closes the communication channels with the SPI devices 106. The host computer 102 can then send new configuration commands to set up the next data transfer operation or power down the FPGA bridge 104 if no further communication is required.

Throughout the communication workflow, the system employs a set of protocols to ensure reliable and synchronized data transfer. These protocols may include:
Command Protocol: The command protocol defines the format and structure of the commands sent from the host computer 102 to the FPGA bridge 104. It specifies the command types, parameters, and error handling mechanisms.
Data Transfer Protocol: The data transfer protocol governs the exchange of data between the host computer 102, the FPGA bridge 104, and the SPI devices 106. It defines the data packet format, flow control mechanisms (e.g., ready/valid signals), and error detection and recovery techniques.
SPI Protocol: The SPI protocol defines the low-level signaling and timing requirements for communication between the FPGA bridge's SPI Primary Controller 114 and the SPI devices 106. It specifies the clock polarity, phase, and data transfer modes supported by the system.

The communication protocols may be implemented using a combination of hardware description languages (HDLs) and high-level synthesis (HLS) tools, ensuring efficient and reliable communication between the system components.

By adhering to this well-defined communication workflow and protocols, the FPGA-based SPI device interface achieves seamless and synchronized data transfer between the host computer 102 and the SPI devices 106, while providing robust error handling and recovery mechanisms to maintain data integrity.

### Exemplary Embodiments

In one exemplary embodiment, the FPGA Bridge 104 may be utilized in a high-speed data acquisition system for industrial sensor monitoring. The system includes a host computer 102, an FPGA bridge 104, and multiple SPI-based sensors 106, such as temperature sensors, pressure sensors, and accelerometers.

The host computer 102 may be an industrial-grade computing device running a data acquisition software application. The computing device may communicate with the FPGA Bridge 104 via a USB 3.0 interface or other interface, which provides high-bandwidth and low-latency communication. The host computer 102 sends configuration commands and data transfer requests to the FPGA bridge 104 and receives the acquired sensor data for further processing and analysis.

The FPGA bridge 104 may include the Host to Device Controller 310, which handles the USB 3.0 communication with the host computer 102. It also incorporates the Data Streaming Controller 112, which manages the efficient data streaming and buffering between the host computer 102 and the SPI devices 106.

The SPI Primary Controller 204, within the FPGA bridge 104, is configured to support multiple SPI modes and clock frequencies, allowing it to interface with a wide range of SPI-based sensors. The SPI Primary Controller 204 may communicate with sensors operating at different clock speeds, ranging from 1 MHz to 50 MHz, and it supports both mode 0 and mode 1 SPI configurations.

The Data Streaming Controller 112 is configured to support the different data rates and packet sizes required by each sensor. For example, the Data Streaming Controller 112 may employ FIFO buffers 208 and/or circular buffers to handle the varying data throughput and ensure smooth data transfer between the sensors and the host computer. The Data Streaming Controller 112 may also implement data packing techniques to optimize the data transfer efficiency, combining multiple sensor readings into larger data packets.

The communication workflow follows the initialization, data transfer, and termination phases described above. During the initialization phase, the host computer 102 sends configuration commands to set up the SPI communication parameters for each sensor. The FPGA bridge 104 configures its SPI Primary Controller 204 accordingly and verifies the presence and functionality of each sensor.

In the data transfer phase, the host computer 102 sends data acquisition requests to the FPGA bridge 104, specifying the desired sensors and the acquisition duration. The Data Streaming Controller 112 manages the data transfer from the sensors, buffering the acquired data and forwarding it to the host computer 102 via a communication interface. The data transfer employs flow control mechanisms and error detection techniques to ensure reliable and synchronized data acquisition.

The system implementation achieves a high data throughput, with a total data rate of up to 200 Mbps, enabling real-time monitoring and analysis of the industrial sensors. The FPGA-based SPI device interface provides low-latency and deterministic data acquisition, ensuring precise timing and synchronization among the sensors.

This exemplary embodiment demonstrates the capabilities of the FPGA-based SPI device interface 104 in a high-speed industrial sensor monitoring application. The system's efficient data streaming, buffering, and communication protocols enable reliable and synchronized data acquisition from multiple SPI-based sensors 106, while the FPGA bridge's reconfigurability allows for easy adaptation to different sensor types and communication requirements.

In a second exemplary embodiment, the system's FPGA-based SPI device interface 104 is applied to a high-density SPI flash memory storage system. The system includes a host computer 102, an FPGA bridge 104, and multiple SPI flash memory devices 106, such as NAND flash or NOR flash. The host computer 102 may be a server-grade system with a PCIe interface 110 for high-speed communication with the FPGA bridge 104. The host computer 102 runs a storage management software that handles data read/write operations, wear leveling, and error correction for the SPI flash memory devices.

This FPGA bridge 104 embodiment may be implemented on a high-performance FPGA offering advanced features such as high-speed transceivers (up to 58 Gbps), hardened memory controllers (DDR4 and QDR-IV), and a large number of configurable logic blocks (up to 2.8 million logic elements). The high-speed transceivers enable efficient PCIe communication with the host computer 102, while the hardened memory controllers support high-bandwidth memory interfaces for the SPI flash memory devices 106. The abundant logic resources available in the FPGA allow for the implementation of complex data streaming, buffering, and error correction algorithms, making it well-suited for the high-density SPI flash memory storage system. The FPGA bridge 104 therefore may include a PCIe endpoint module 116 that communicates with the host computer 102 using the PCIe protocol. The Host to Device Controller Module 310 within the FPGA bridge 104 manages the PCIe communication and translates the storage commands from the host computer into SPI commands for the flash memory devices.

The Data Streaming Controller 112 in the FPGA bridge 104 may be configured for high-throughput data transfer between the host computer 102 and the SPI flash memory devices 106. For example, the Data Streaming Controller 112 may incorporate large FIFO buffers and high-performance DMA engines to handle the data streaming and buffering requirements of the storage system. The Data Streaming Controller 112 may also implement error detection and correction mechanisms, such as ECC (Error Correction Code) and CRC (Cyclic Redundancy Check), to ensure data integrity during the read/write operations.

The SPI Primary Controller 312 in the FPGA bridge 104 is configured to support high-speed SPI communication with multiple flash memory devices 106. In some instances, the SPI Primary Controller 312 can operate at clock frequencies up to 200 MHz and support both single and dual SPI modes. The SPI Primary Controller 312 may also incorporate advanced features, such as quad SPI (QSPI) and execute-in-place (XIP) functionality to enhance the read/write performance and enable direct code execution from the flash memory devices. Further, SPI Primary Controller 312 may be configured to support concurrent communication with eight SPI eight devices, enabling parallel read/write operations and maximizing the overall system throughput.

The communication workflow follows the standard initialization, data transfer, and termination phases. During the initialization phase, the host computer 102 sends configuration commands to the FPGA bridge 104 to set up the SPI communication parameters, such as clock frequency, data transfer mode, and memory mapping. The FPGA bridge 104 configures the SPI Primary Controller 312 and performs device identification and initialization for each connected flash memory device.

In the data transfer phase, the host computer 102 sends read/write commands and data to the FPGA bridge 104 via the PCIe interface 110. The Host to Device Controller 310 interprets the commands and forwards them to the Data Streaming Controller 112. The Data Streaming Controller 112 manages the data buffering and transfer between the host computer 102 and the SPI flash memory devices 106, utilizing its high-performance DMA engines and error correction mechanisms. The SPI Primary Controller 312 executes the read/write operations on the flash memory devices based on the received commands and data.

The embodiment in this scenario achieves a high aggregate data throughput leveraging the parallel communication capabilities of the FPGA bridge 104 and the concurrent operation of the SPI flash memory devices 106. The FPGA-based SPI device interface 204 provides low-latency and deterministic data access, enabling fast and reliable storage operations. The aggregate data throughput is limited only by the FPGA and not by this system's design.

This exemplary embodiment showcases the capabilities of the FPGA-based SPI device interface 104 in a high-density SPI flash memory storage system. The system's advanced data streaming, buffering, and error correction techniques, combined with the high-performance FPGA bridge 104 and optimized SPI communication, enable efficient and reliable data storage and retrieval from multiple SPI flash memory devices.

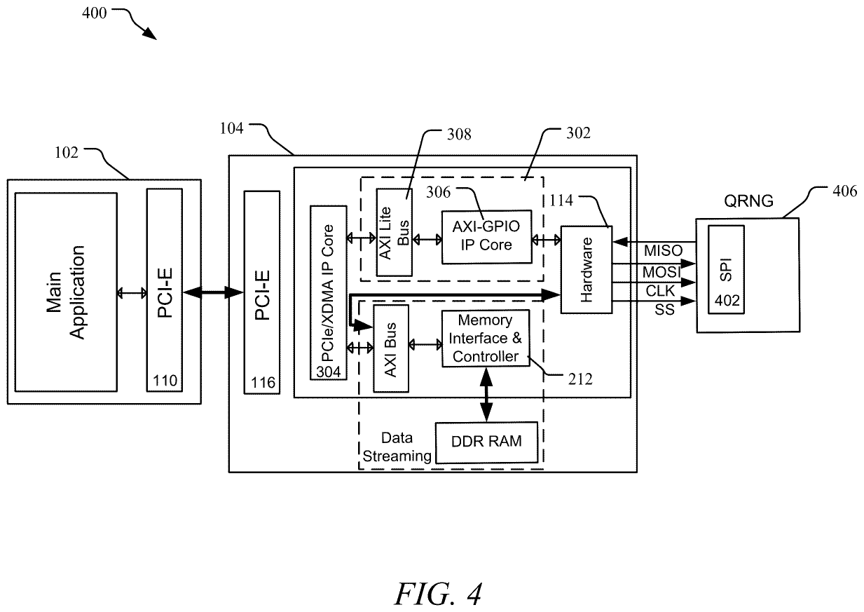

In the example illustrated in FIG. 4, the FPGA-based SPI device interface 104 is utilized in a quantum random number generator (QRNG) system 406 based on photodiodes as a source of quantum noise. This example includes a host computer 102, an FPGA bridge 104, and an array of photodiodes 406 connected via SPI interface 402.

The host computer 102 may be, in one implementation, a high-performance workstation running a quantum cryptography application that utilizes a continuous stream of high-quality random numbers. The host computer 102 communicates with the FPGA bridge 104 using a high-speed interface 110 to send configuration commands and receive generated random number data.

The FPGA bridge 104 in this embodiment combines a high-performance FPGA fabric with a multi-core ARM processor. The Host to Device Controller 310 within the Hardware 114 of the FPGA bridge 104 manages the communication and interprets the configuration commands from the host computer 102.

The photodiode array 406 may include sixteen high-sensitivity, low-noise photodiodes that serve as a source of quantum noise. Each photodiode is connected to the FPGA bridge 104 via a dedicated SPI interface 402, allowing for parallel data acquisition. The photodiodes 406 are operated in a reverse-biased mode, where the shot noise generated by the random arrival of photons is the dominant source of quantum noise.

The Data Streaming Controller 212 in the FPGA bridge 104 is optimized for high-speed data acquisition from the photodiode array 406 and may incorporate a multi-channel ADC (Analog-to-Digital Converter) to sample the analog output of the photodiodes 406 at a high sampling rate, typically in the range of 100 MHz to 1 GHZ. The Data Streaming Controller 212 may also include a high-performance digital signal processing (DSP) pipeline to condition and process the sampled data, removing any bias and ensuring the randomness of the generated numbers.

The SPI Primary Controller 312 of the Hardware 114 (illustrated in FIG. 3) in the FPGA bridge 104 is configured to support high-speed SPI communication with the photodiode array 406. It operates at a clock frequency of 50 MHz and utilizes a custom SPI protocol optimized for low-latency data transfer. The SPI Primary Controller 312 communicates with each photodiode sequentially, acquiring the sampled quantum noise data.

The QRNG system 406 may operate in two main phases: initialization and random number generation. During the initialization phase, the host computer 102 sends configuration commands to the FPGA bridge 104, specifying the sampling rate, data processing parameters, and output format. The FPGA bridge 104 configures its Data Streaming Controller 212 and SPI Primary Controller 312 accordingly and initializes the photodiode array 406.

In the random number generation phase, the FPGA bridge 104 continuously acquires quantum noise data from the photodiode array 406 via the SPI interface 402. The Data Streaming Controller's ADC samples the photodiode outputs 406 and the DSP pipeline processes the sampled data to extract the random bits. The generated random numbers are then packaged into data packets and transmitted to the host computer 102 via the interface 104.

The implementation 400 achieves a high random number generation rate of up to 1 Gbps, leveraging the parallel acquisition from the photodiode array 406 and the high-speed data processing capabilities of the FPGA bridge 104. The FPGA-based SPI device interface 104 ensures low-latency and deterministic data transfer, preserving the quality and integrity of the generated random numbers.

This exemplary embodiment demonstrates the versatility of the system's FPGA-based SPI device interface 104 in a quantum random number generation system using photodiodes 406 as a source of quantum noise. The system's high-speed data acquisition, digital signal processing, and optimized SPI communication enable the efficient extraction of high-quality random numbers from the quantum noise of the photodiodes, providing a reliable source of entropy for quantum cryptography applications.

In yet another example, the FPGA-based SPI device interface 104 may be employed in a quantum random number generator (QRNG) system 406 that utilizes a photonic chip as a source of quantum noise. The system includes a host computer 102, coupled with the FPGA bridge 104, and a photonic chip with integrated photodetectors 406, all connected via SPI interface.

Similar to above, the host computer 102 may be a high-performance server running a quantum cryptography application that utilizes a high-quality and high-speed source of random numbers. It communicates with the FPGA bridge 104 using a PCI Express (PCIe) interface 110, providing low-latency and high-bandwidth data transfer.

This implementation of the system offers advanced features such as high-speed transceiver channels and a hardened PCIe endpoint. The FPGA bridge 104 therefore includes a PCIe Root Port module 116 that communicates with the host computer 102 using the PCIe protocol. The Host to Device Controller 310 within the Hardware 114 within the FPGA bridge 104 manages the PCIe communication and interprets the configuration commands from the host computer 102.

The photonic chip 406 may be a custom-designed integrated circuit that incorporates a laser source, optical waveguides, beam splitters, and an array of high-speed photodetectors. The laser source generates a continuous stream of photons, which are then guided through the optical waveguides and split into multiple paths using beam splitters. The photodetectors are positioned at the output of the waveguides to detect the arrival of photons. The inherent quantum uncertainty in the photon path selection and arrival time serves as the source of quantum noise.

The Data Streaming Controller 212 in the FPGA bridge 104 may be optimized for high-speed data acquisition from the photonic chip. It includes a multi-channel time-to-digital converter (TDC) that precisely measures the arrival time of photons at each photodetector. The TDC operates at a high resolution, typically in the range of picoseconds, to capture the fine-grained temporal information of the photon arrivals. The Data Streaming Controller 212 also incorporates a high-performance digital signal processing (DSP) pipeline to process the timestamp data, extract the random bits, and apply post-processing techniques such as randomness extraction and bias correction.

The SPI Primary Controller 312 in the FPGA bridge 104 is configured to support high-speed SPI communication with the photonic chip. It may operate at a clock frequency of 100 MHz and utilizes a custom SPI protocol optimized for low-latency data transfer. The SPI Primary Controller 312 communicates with the photonic chip to configure the laser source, control the photodetectors, and retrieve the timestamp data.

The QRNG system 406 operates in two main phases: initialization and random number generation. During the initialization phase, the host computer 102 sends configuration commands to the FPGA bridge 104, specifying the operating parameters of the photonic chip 406, such as laser power, photodetector settings, and data processing algorithms. The FPGA bridge 104 configures its Data Streaming Controller 212 and SPI Primary Controller 312 accordingly and initializes the photonic chip.

In the random number generation phase, the photonic chip 406 continuously generates a stream of photons, and the photodetectors capture their arrival times. The FPGA bridge's Data Streaming Controller 212 acquires the timestamp data from the photonic chip via the SPI interface 402, and the DSP pipeline processes the data to extract the random bits. The generated random numbers are then packaged into data packets and transmitted to the host computer 102 via the PCIe interface 116.

The system's implementation achieves an ultra-high random number generation rate of up to 10 Gbps, leveraging the high-speed photonic integrated circuit and the advanced data processing capabilities of the FPGA bridge 104. The FPGA-based SPI device interface ensures low-latency and deterministic data transfer, preserving the quality and integrity of the generated random numbers.

This implementation showcases the potential of the FPGA-based SPI device interface 104 in a quantum random number generation system using a photonic chip 406 as a source of quantum noise. The high-speed data acquisition, precise timestamp measurement, and optimized SPI communication discussed above enable the efficient extraction of high-quality random numbers from the quantum uncertainty of photon paths, providing a reliable and scalable source of entropy for quantum cryptography applications.

In another implementation, the FPGA-based SPI device interface 104 may be utilized in a quantum random number generator (QRNG) system 406 that leverages the quantum noise from an atomic clock, specifically the decay or drift of the atomic states. The embodiment's implementation is designed for both earth-based and outer space applications, including a host computer 102, coupled with the FPGA bridge 104, and an atomic clock module 406 connected via an SPI interface 402.

In this example, the host computer 102 is a radiation-hardened, space-grade computer system that runs the quantum cryptography and satellite communication applications requiring a reliable and secure source of random numbers. The host computer 102 communicates with the FPGA bridge 104 using a suitable interface, such as a Space Wire interface, which is a standard communication protocol for space applications, providing high-speed and fault-tolerant data transfer.

The FPGA bridge 104 is implemented on a space-grade FPGA, employing circuits which are specifically designed for the harsh environment of outer space. The FPGA bridge 104 may include a Space Wire IP core that handles the communication with the host computer 102. The Host to Device Controller 310 of the FPGA bridge 104 manages the Space Wire communication and interprets the configuration commands from the host computer 102.

The atomic clock module is a compact and rugged device that contains a high-precision atomic oscillator, such as a cesium or rubidium atomic clock. The atomic clock generates a highly stable and accurate frequency reference based on the hyperfine transition of the atomic states. However, the quantum nature of the atomic transitions introduces inherent uncertainties and noise in the clock signal, which can be harnessed as a source of quantum entropy.

The Data Streaming Controller 212 in the FPGA bridge 104 is optimized for high-speed data acquisition from the atomic clock module. It includes a high-resolution time-to-digital converter (TDC) that captures the timing variations in the atomic clock signal with sub-picosecond precision. The TDC measures the jitter and phase noise of the clock signal, which are manifestations of the quantum noise. The Data Streaming Controller 212 also incorporates a digital signal processing (DSP) pipeline to analyze the captured timing data, extract the random bits, and apply post-processing techniques such as randomness extraction and cryptographic whitening.

The SPI Primary Controller 312 in the FPGA bridge 104 is configured to support high-speed SPI communication with the atomic clock module. It operates at different clock frequencies, such as 50 MHz, and utilizes a custom SPI protocol optimized for reliable data transfer in the space environment. The SPI Primary Controller 312 communicates with the atomic clock module to configure its operating parameters, control the clock output, and retrieve the timing data.

During an initialization phase, the host computer 102 sends configuration commands to the FPGA bridge 104, specifying the operating mode of the atomic clock, the TDC settings, and the data processing algorithms. The FPGA bridge 104 configures its Data Streaming Controller 212 and SPI Primary Controller 312 accordingly and initializes the atomic clock module.

In the random number generation phase, the atomic clock module continuously generates the highly stable clock signal, and the FPGA bridge's Data Streaming Controller 212 captures the timing variations using the TDC. The DSP pipeline processes the timing data to extract the random bits, applying the necessary post-processing techniques. The generated random numbers are then packaged into data packets and transmitted to the host computer 102 via the Space Wire interface.

The system achieves a robust and reliable random number generation rate of up to 100 Mbps, leveraging the inherent quantum noise of the atomic clock and the high-precision data acquisition capabilities of the FPGA bridge 104. The FPGA-based SPI device interface ensures low-latency and deterministic data transfer, preserving the quality and integrity of the generated random numbers in the demanding space environment.

This example highlights the adaptability of the FPGA-based SPI device interface 104 in a quantum random number generation system using an atomic clock as a source of quantum noise, suitable for both earth-based and outer space applications. The system's high-precision timing measurement, robust data processing, and space-grade components enable the generation of high-quality random numbers from the quantum uncertainty of atomic clock drift, providing a reliable source of entropy for secure satellite communication and quantum cryptography in space.

In yet another example, the FPGA-based SPI device interface 104 is employed in a quantum random number generator (QRNG) system 406 that utilizes an atomic clock as a reference to divide and classify other sources of entropy or randomness. The system is designed for both earth-based and outer space applications, including a host computer 102, an FPGA bridge 104, an atomic clock module, and multiple entropy sources, all connected via SPI interfaces.

The host computer 102 may be a high-performance, space-grade computer system running quantum cryptography and satellite communication applications that require a reliable and high-quality source of random numbers. It communicates with the FPGA bridge 104 using a high-speed, radiation-tolerant communication protocol, such as SpaceFibre or SerialRapidIO.

The FPGA bridge 104 is implemented on a space-grade FPGA which offers high performance and radiation tolerance. The FPGA bridge 104 includes dedicated IP cores for the chosen communication protocol, ensuring reliable data transfer with the host computer. The Host to Device Controller 310 within the FPGA bridge 104 manages the communication and interprets the configuration commands from the host computer 102.

The atomic clock module serves as a highly precise and stable time reference for the QRNG system 406. It generates a low-phase-noise clock signal based on the hyperfine transition of atoms, such as cesium or rubidium. The atomic clock provides a reliable timing source to synchronize and classify the entropy sources.

This exemplary embodiment incorporates multiple entropy sources, such as:
a. Radioactive decay: A radioactive source, such as a small sample of uranium or thorium, is used to generate random events through radioactive decay.
b. Photon arrival time: A single-photon detector is used to measure the random arrival times of photons from a weak light source, such as a light-emitting diode (LED) or a laser diode.
c. Chaotic oscillator: A non-linear electronic oscillator, such as a Chua's circuit or a logistic map circuit, generates chaotic signals with high sensitivity to initial conditions.

Each entropy source is connected to the FPGA bridge 104 via its dedicated SPI interface 402, allowing for independent data acquisition and control.

The Data Streaming Controller 212, within the FPGA bridge 104, is designed to efficiently acquire and process data from the multiple entropy sources. It includes high-speed analog-to-digital converters (ADCs) and time-to-digital converters (TDCs) to capture the analog signals and timing information from the entropy sources. The Data Streaming Controller 212 also incorporates a multi-stage digital signal processing (DSP) pipeline to perform real-time data analysis, classification, and randomness extraction.

The atomic clock measurements are used to divide the data from the entropy sources into precise time bins. The DSP pipeline analyzes the statistical properties of the data within each time bin, such as the distribution, autocorrelation, and entropy estimates. Based on these properties, the data is classified into different categories of randomness quality. The DSP pipeline then applies appropriate post-processing techniques, such as randomness extraction and cryptographic hashing, to combine the data from different entropy sources and generate high-quality random numbers.

The SPI Primary Controller 312 in the FPGA bridge 104 is configured to support high-speed, low-latency SPI communication with the atomic clock module and the entropy sources. It operates at a configurable clock frequency up to 100 MHZ and implements a custom SPI protocol optimized for reliable data transfer in the space environment.

During an initialization phase, the host computer 102 sends configuration commands to the FPGA bridge 104, specifying the operating parameters for the atomic clock, entropy sources, and data processing algorithms. The FPGA bridge 104 configures its Data Streaming Controller 212, SPI Primary Controller 312, and initializes the atomic clock and entropy sources.

In the random number generation phase, the atomic clock provides the precise timing reference, and the entropy sources continuously generate random events. The Data Streaming Controller 212 acquires the data from the entropy sources, and the DSP pipeline processes the data in real-time, using the atomic clock measurements to classify and combine the randomness from different sources. The generated random numbers are then packaged and transmitted to the host computer 102 via the high-speed communication interface.

This exemplary embodiment achieves a high-quality and robust random number generation rate, leveraging the atomic clock's precision and the diversity of entropy sources. The FPGA-based SPI device interface 104 enables low-latency, deterministic data acquisition and control, ensuring the integrity and quality of the generated random numbers in the demanding space environment.

This examples demonstrates the versatility of the FPGA-based SPI device interface 104 in a QRNG system 406 that utilizes atomic clock measurements to divide and classify multiple sources of entropy, suitable for both earth-based and outer space applications. The system's precise timing reference, real-time data processing, and robust design enable the generation of high-quality random numbers by intelligently combining the randomness from diverse entropy sources, enhancing the reliability and security of quantum cryptography and satellite communication applications.

### Advantages

The FPGA-based SPI device interface 104 disclosed herein offers several significant advantages over conventional SPI interface implementations. These advantages make it well-suited for a wide range of applications, from high-speed sensor data acquisition to quantum random number generation. Some advantages of the system are as follows:

1. Flexibility and Reconfigurability: In the system, employing the FPGA as the intermediary bridge facilitates unparalleled flexibility and reconfigurability, allowing for real-time updates and modifications to the communication protocols, data processing algorithms, and custom logic functions, without necessitating hardware changes. The FPGA can be programmed to support various SPI modes, clock frequencies, and custom protocols, allowing it to interface with a diverse range of SPI devices. The FPGA's reconfigurability enables easy adaptation to changing system requirements or the integration of new SPI devices without the need for hardware modifications.

2. High-Speed Data Transfer: The disclosed system achieves superior data transfer rates by leveraging the FPGA's parallel processing capabilities, significantly surpassing traditional microcontroller-based implementations, and directly addressing the throughput limitations often encountered in high-data-volume applications. The FPGA's parallel processing capabilities and dedicated high-speed communication interfaces, such as USB 3.0, PCIe, or SpaceWire, enable data transfer rates in the range of hundreds of Mbps to several Gbps. This high-speed data transfer is crucial for applications that require real-time processing, such as high-resolution sensor data acquisition or quantum random number generation.

3. Low Latency and Deterministic Timing: The FPGA's hardware-based implementation of the SPI protocol ensures low latency and deterministic timing in the communication between the host computer and the SPI devices. The FPGA can handle the SPI communication tasks independently, without the overhead of software layers or operating system interrupts. This deterministic timing is essential for applications that require precise synchronization and real-time control, such as industrial automation or scientific instrumentation.

4. Scalability and Expandability: The disclosed FPGA-based SPI device interface can be easily scaled to support a large number of SPI devices without compromising performance. The FPGA's abundant I/O resources and the ability to instantiate multiple SPI Master Controller modules enable concurrent communication with numerous SPI devices. This scalability is valuable in applications that require data acquisition from a dense array of sensors or parallel processing of multiple data streams.

5. Robustness and Reliability: To ensure robustness and data integrity, the system incorporates advanced error detection and correction mechanisms, including but not limited to Cyclic Redundancy Checks (CRC) and Error-Correcting Codes (ECC), fully integrated into the FPGA's hardware. These mechanisms are critical for applications requiring high reliability and accuracy, such as data acquisition and quantum cryptography. The use of FIFO buffers and data flow control techniques prevents data loss and ensures reliable communication even in the presence of varying data rates or intermittent connectivity. The FPGA's inherent parallel processing capabilities also enable the implementation of redundancy and fault-tolerance features, enhancing the overall system reliability.

6. Customization and IP Integration: The FPGA-based SPI device interface allows for extensive customization and the integration of intellectual property (IP) cores. The FPGA's programmable fabric can be used to implement custom data processing algorithms, digital signal processing, or encryption techniques, tailored to the specific application requirements. The FPGA can also incorporate third-party IP cores, such as communication protocols, digital filters, or machine learning accelerators, enabling the creation of highly specialized and efficient SPI-based systems.

7. Power Efficiency: The FPGA's power efficiency is an advantage, especially in resource-constrained or power-sensitive applications. The FPGA's ability to implement hardware-based power management techniques, such as clock gating or dynamic voltage and frequency scaling, allows for fine-grained control over power consumption. The FPGA can also be configured to optimize power usage based on the specific requirements of the connected SPI devices, enabling energy-efficient operation in battery-powered or remotely deployed systems.

8. Cost-Effectiveness: The FPGA-based SPI device interface offers a cost-effective solution for high-performance SPI communication. FPGAs provide a balance between the flexibility of software-based implementations and the performance of application-specific integrated circuits (ASICs). The FPGA's reconfigurability eliminates the need for costly hardware redesigns when system requirements change, and the ability to reuse IP cores and design modules reduces development time and effort. The FPGA-based approach also enables rapid prototyping and iterative design, lowering the overall cost of system development and deployment.

These advantages make the FPGA-based SPI device interface 104 a compelling choice for a wide range of applications, from industrial automation and scientific instrumentation to aerospace and quantum computing. The combination of flexibility, high-speed data transfer, deterministic timing, scalability, robustness, customization, power efficiency, and cost-effectiveness opens up new possibilities for SPI-based systems, enabling the development of innovative and high-performance solutions.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### ADDITIONAL CONSIDERATIONS

The foregoing described embodiments have been presented for the purpose of illustration; they are not intended to be exhaustive or to limiting to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, described modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include one or more general-purpose computing devices selectively activated or reconfigured by one or more stored computer programs. A computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Described embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A Serial Peripheral Interface (SPI) device interface system comprising:
a host computer interface in operable communication with a host computer;
a SPI device interface in operable communication with at least one SPI device; and
a Field Programmable Gate Array (FPGA) bridge in communication with and between the host computer interface and the SPI device interface, the FPGA bridge comprising:
a Host to Device Controller configured to synchronize host device communications between the host computer and the FPGA bridge through the host computer interface, the host device communications in a first communication protocol different than an SPI communication peripheral;
a Data Streaming Controller configured to handle data transfer through the FPGA bridge and between the host computer and the at least one SPI device via a plurality of data buffers; and
an SPI Primary Controller configured to control SPI communications with the at least one SPI device through the SPI device interface.

2. The SPI device interface system of claim 1, wherein the Host to Device Controller interprets commands received from the host computer and configures the Data Streaming Controller and SPI Primary Controller in response.

3. The SPI device interface system of claim 1, wherein the Data Streaming Controller comprises FIFO (First-In-First-Out) buffers for buffering data between the host computer and the at least one SPI device.

4. The SPI device interface system of claim 1, wherein the Data Streaming Controller is configured to perform error detection and correction on the data being transferred to verify integrity of the data transmitted between the host computer and the SPI devices.

5. The SPI device interface system of claim 1, wherein the at least one SPI device comprises a single SPI secondary device, multiple SPI secondary devices, a single SPI primary device, or multiple primary SPI devices.

6. The SPI device interface system of claim 1, wherein the FPGA bridge and the at least one SPI device communicate using a high-speed communication interface comprising at least one of a Universal Serial Bus (USB) 3.0, a Peripheral Component Interconnect Express (PCIe), or a Space Wire interface.

7. The SPI device interface system of claim 1, wherein the at least one SPI device comprises at least one of a sensor, an actuator, a memory device, or a quantum entropy-generating device, including at least one of a photodiode, photonic chip, or atomic clock module.

8. The SPI device interface system of claim 1, wherein the FPGA bridge is programmable to be reconfigured to adapt to one or more altered system requirements of the host computer.

9. The SPI device interface system of claim 1, wherein the FPGA bridge is programmable to be reconfigured to integrate one or more additional SPI devices.

10. The SPI device interface system of claim 1, wherein the FPGA bridge is programmable to comprise concurrent communication with multiple SPI devices by instantiating multiple SPI Primary Controllers configured for concurrent communication.

11. A method comprising:
configuring a Field Programmable Gate Array (FPGA) bridge to comprise a Host to Device Controller, a Data Streaming Controller, and an SPI Primary Controller;
establishing communication between a host computer and the FPGA bridge;
connecting at least one SPI device to the FPGA bridge;
interpreting commands received from the host computer by the Host to Device Controller;
configuring the Data Streaming Controller and the SPI Primary Controller based on the interpreted commands;
transferring data between the host computer and the at least one SPI device through the Data Streaming Controller; and
controlling SPI communication with the at least one SPI device using the SPI Primary Controller.

12. The method of claim 11, further comprising:
buffering data between the host computer and the at least one SPI device using one or more First In, First Out (FIFO) buffers in the Data Streaming Controller.

13. The method of claim 11, further comprising:
performing error detection and correction during the transfer of data using the Data Streaming Controller.

14. The method of claim 11, wherein the at least one SPI device comprises a single SPI secondary device, multiple SPI secondary devices, a single SPI primary device, or multiple primary SPI devices.

15. The method of claim 11, further comprising:
reconfiguring the FPGA bridge to adapt to one or more altered system requirements of the host computer.

16. The method of claim 11, further comprising:
reconfiguring the FPGA bridge to integrate one or more additional SPI devices.

17. The method of claim 11, wherein the FPGA bridge and the at least one SPI device communicate using a high-speed communication interface comprising at least one of a Universal Serial Bus (USB) 3.0, a Peripheral Component Interconnect Express (PCIe), or a SpaceWire interface.

18. The method of claim 11, wherein the at least one SPI device comprises at least one of a sensor, an actuator, a memory device, or a device generating quantum entropy.

19. A method for classifying entropy from a plurality of sources in a serial peripheral interface (SPI)-based system, the method comprising:
receiving entropy data from a plurality of entropy sources communicatively coupled to an FPGA via respective SPI interfaces;
applying an atomic clock reference to segment the received entropy data into discrete timing bins;
analyzing the entropy data within each timing bin to compute one or more statistical metrics indicative of entropy quality;
extracting random bits from the entropy data using a digital signal processing pipeline configured for randomness qualification and post-processing; and
transmitting the extracted random bits to a host computer via a high-speed data interface.

20. The method of claim 19, wherein the entropy sources comprise at least one of a photonic chip, a photodiode array, a radioactive decay sensor, or a chaotic oscillator.

21. The method of claim 19, wherein the digital signal processing pipeline comprises a time-to-digital converter (TDC), a statistical entropy estimator, and a randomness extractor.

22. The method of claim 19, wherein the high-speed data interface comprises at least one of a PCIe interface, a USB 3.0 interface, or a Space Wire interface.
